(19) United States
(12) Patent Application Publication
(10) Pub. No.: US 2021/0382893 A1
(43) Pub. Date: Dec. 9, 2021

(54) INTELLIGENTLY IDENTIFYING THE MOST KNOWLEDGABLE PERSON BASED ON MULTIPLE DATA SOURCE INPUTS

(71) Applicant: Dropbox, Inc., San Francisco, CA (US)

(72) Inventors: Madan Kumar, Fremont, CA (US); Sravan Mantha, Dublin, CA (US); Neeraj Kumar, Brooklyn, NY (US)

(21) Appl. No.: 16/895,559

(22) Filed: Jun. 8, 2020

(51) Int. Cl. G06F 16/2453; G06F 16/23; G06N 5/04; G06N 20/00

(52) U.S. Cl. CPC G06F 16/24539; G06F 16/2358; G06N 20/00; G06N 5/04; G06F 16/2365

(57) ABSTRACT

The present disclosure is directed toward systems and methods that efficiently and effectively identify experts relative to a key topic within an organization. For example, systems and methods described herein can receive an expert assistance query from a user looking for an expert associated with a particular topic. Systems and methods described herein can further apply a trained expert selection model to a key topic extracted from the received expert assistance query. In response to receiving an identified expert from the expert selection model, systems and methods can further identify and provide information associated with the identified expert such as the expert's contact information, the expert's team information, and other data (e.g., documents, emails, communications) authored by the expert in association with the key topic.

### BACKGROUND

Recent years have seen significant improvements in interpersonal digital connectivity. For example, conventional systems can provide a user with quick electronic access to co-users across organizations and other networks. To illustrate, within a company, conventional systems can provide a user with access to other users within the company including email access, messaging access, and document repository access. Despite these advancements, conventional systems have a number of problems with regard to flexibility, accuracy, and efficiency of operation when it comes to identifying and contacting a person within an organization that has specialized experience or knowledge. For example, it is often the case that a user needs to identify an individual within an organization that is the leader or expert with regard to a specific topic. Indeed, many conventional systems do not provide any meaningful way for a user to identify such an individual and the user is left no choice but to go through a time consuming process of sending out multiple communications to multiple users until an expert is finally located.

Some conventional systems attempt to keep track of responsibilities of personnel within an inflexible organization hierarchy database. Indeed, conventional systems generally attempt to maintain an organization hierarchy database of company employees, projects, and teams. However, conventional organization hierarchy databases are often too inflexible for modern fast-moving organizations that identify and form new teams on-the-fly and disband old teams on an as-needed basis. Indeed, the practicalities of modern organizations render the conventional organization hierarchy database an antiquated and often useless method for a person to attempt to identify an individual within a company with specific knowledge about a particular topic due to the conventional organization hierarchy database being inaccurate in identifying current experts as well as keeping an accurate history of experts for projects that may no longer be on-going.

Moreover, conventional system organization hierarchy databases are further inaccurate because conventional organization hierarchy databases often only include very high-level data about an employee's position or title. This high-level data is often not granular enough to provide any useful indication of whether a particular person is an expert with respect to a particular topic or project, let alone a particular part of a project, for example. Accordingly, the inaccuracies of conventional organizational hierarchy databases are based not only on out-of-date information, but also conventional systems are inaccurate because they are not capable of providing a useful level of data granularity to properly identify an expert with respect to a particular area.

In addition to the problems with regard to flexibility, accuracy, and efficiency of discussed above, conventional systems further rely on excessive user interactions with multiple graphical user interfaces to allow a user to attempt to search and identify an expert. For example, to identify a potential expert associated with a topic, a conventional system user generally ends up conducting various searches within multiple applications as well as sends multiple communications to various co-users to attempt to identify an expert. This level of excessive user interaction with conventional graphical user interfaces is inefficient and takes multiple user steps with various applications and graphical user interfaces to attempt to accomplish the goal of identifying an expert.

These along with additional problems and issues exist with regard to conventional systems.

### BRIEF SUMMARY

Embodiments of the present disclosure provide benefits and/or solve one or more of the foregoing or other problems in the art with systems, non-transitory computer-readable media, and methods for intelligently identifying a most knowledgeable person (e.g., an expert) associated with a topic based on multiple data source inputs. For example, a content management system can receive an expert assistance query from a user in search of an expert related to a particular topic. In response to receiving the expert assistance query, the content management system can access a model trained on organizational data (e.g., emails, documents, code, instant messages, and comments) to identify and provide information associated with users who are most knowledgeable about the particular topic. The content management system can also provide team information, documents, emails, communications, digital presentations, and other data that may help answer the user's query.

In order to identify experts, the content management system can access multiple data source inputs from both inside and outside the content management system to train an expert selection model in an offline mode. For example, prior to receiving any query, the content management system can utilize emails, text messages, computer code, digital documents, digital presentations, digital calendars, organizational data, digital media, and other data from a variety of sources to train the expert selection model to output an identified expert in response to receiving a key topic from an expert assistance query. Then, in response to receiving a new query in an online mode, the content management system can apply the trained expert selection model to the new query in order to identify an appropriate expert user. The content management system can provide information associated with the identified expert along with particularly relevant documents, computer code, digital media, and so forth in order to assist the querying user in becoming knowledgeable relevant to the queried key topic.

Additional features and advantages of the present invention will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of a system for implementing the content management system in accordance with one or more embodiments described herein;

FIGS. 2A-2B illustrate an overview schematic diagram for identifying an expert associated with a key topic in accordance with one or more embodiments described herein;

FIGS. 3A-3C illustrate example graphical user interfaces of the content management system in accordance with one or more embodiments described herein;

FIGS. 4A-4B illustrate example graphical user interfaces of the content management system in accordance with one or more embodiments described herein;

FIG. 5A-5B illustrate example graphical user interfaces of the content management system in accordance with one or more embodiments described herein;

FIG. 6 illustrates a schematic diagram of processing an expert assistance query in accordance with one or more embodiments described herein;

FIG. 7A-7B illustrate schematic diagrams related to an expert selection model in accordance with one or more embodiments described herein;

FIG. 8 illustrates a schematic diagram of the content management system in accordance with one or more embodiments described herein;

FIG. 9 illustrates a flowchart of a series of acts in a method of identifying and providing information associated with an expert relative to an expert assistance query in accordance with one or more embodiments described herein;

FIG. 10 illustrates a block diagram of an exemplary computing device in accordance with one or more embodiments described herein; and

FIG. 11 is an example network environment of a content management system in accordance with one or more embodiments described herein.

### DETAILED DESCRIPTION

This disclosure describes one or more embodiments of a content management system that leverages a variety of data sources to accurately identify a most knowledgeable person associated with a particular topic and to quickly provide information associated with the most knowledgeable person to a querying user. For example, the content management system can utilize multiple data sources associated with multiple users to train an expert selection model. In response to receiving an expert assistance query, the content management system can apply the trained expert selection model to a key topic extracted from the expert assistance query in order to identify an expert associated with the key topic. The content management system can further identify and provide information associated to the expert and query, such as the expert's team, the experts contact information, relevant documents, emails, and other media associated with both the expert and the key topic. Accordingly, the content management system intelligently utilizes a wide range of data sources to quickly and accurately identify an expert related to a key topic in response to a single query from a user.

To further illustrate, in one or more embodiments, the content management system can access a variety of data sources to train an expert selection model and build a repository of experts associated with a range of key topics. For example, the content management system can access data sources that are internal to a particular organization including, but not limited to, email data sources (e.g., email servers), electronic messaging data sources (e.g., chat servers), document data sources (e.g., electronic document repositories), digital presentation data sources, digital media data sources, digital calendar data sources, social network data sources (e.g., internal newsfeeds), and organizational information (e.g., employment hierarchy data, employee position information, resume data). Additionally, the content management system can access data sources that are external to a particular organization including, but not limited to, third-party communication servers and data repositories, external social networking systems, and linked data sources (e.g., linked personal devices such as a mobile phone, tablet, and/or smart wearable devices).

In one or more embodiments, the content management system can utilize these data sources to train an expert selection model (e.g., in an offline mode). For example, the content management system can generate ground truth training data by extracting one or more users associated with each data input. The content management system can utilize this ground truth training data to train the expert selection model to output an identified user (e.g., an expert or most knowledgeable person) in response to receiving an expert assistance query that references a topic.

The content management system can further receive an expert assistance query from a querying user (e.g., in an online mode). For example, the content management system can apply the trained expert selection model to a received expert assistance query in order to identify an expert that corresponds to a key topic corresponding to the expert assistance query. In one or more embodiments, the content management system can apply the trained expert selection model to the query by extracting the key topic and generating an input vector for the expert selection model based on the extracted key topic. The content management system can further receive the identified expert associated with the extracted key topic from the expert selection model.

In at least one embodiment, the content management system can further identify a team or project associated with the identified user, along with particularly relevant emails, documents, communications, and/or media associated with the both the identified expert and the expert assistance query. For example, the content management system can access organizational data to determine a team associated with the identified expert. Thus, if the identified expert is not available for contact, the querying user can reach out to other team members who are likely to have relevant information associated with the key topic.

Moreover, in addition to the identified expert and associated team information, the content management system can identify and provide additional relevant information. For example, in response to identifying an expert associated with the key topic, the content management system can further analyze data sources associated with that expert to identify particularly relevant documents, computer code, digital presentations, and so forth. In at least one embodiment, the content management system can provide these relevant data sources along with contact information associated with the expert to the querying user in an effort to help the querying user educate him or herself.

In one or more embodiments, the content management system can identify and provide information associated with additional experts. For example, the content management system can provide a variable number of experts in response to receiving an expert assistance query. In at least one embodiment, the content management system can train the expert selection model to output experts associated with a key topic in ranked order such that the expert selection model first outputs the highest ranking expert, and then in successive applications outputs lesser ranking experts. The content management system can identify and provide information associated with all the identified experts such that the querying user may contact lesser ranking experts if the highest ranking expert is unavailable.

In at least one embodiment, the content management system implements a feedback loop in order to determine whether an identified expert is correct and/or helpful. For example, the content management system can seek feedback from both the querying user as we well as the identified expert requesting whether the identified expert was, for example, knowledgeable regarding the key topic, able to be reached based on the provided contact information, willing to be contacted again regarding the key topic from another user, or the name of a better suited expert for the key topic. Based on the received feedback, the content management system can retrain the expert selection model to more accurately identify experts associated with a key topic in the future.

The content management system provides many advantages and benefits over conventional systems and methods. For example, by training an expert selection model, the content management system improves flexibility relative to conventional systems. Specifically, by training and retraining the expert selection model with updated data from multiple data sources, the content management system exhibits a flexible approach that avoids conventional system's reliance on static data. Indeed, the expert selection model's design allows the model to be continuously updated based on monitoring data sources that naturally track a user's expertise within an organization. Thus, the expert selection model provides a solution that flexibly adapts to be in sync with how a particular organization works by seamlessly creating an expert selection model based on data the organization is naturally creating as expertise within the organization ebbs and flows from one person to the next through the course of project creation, project termination, team creation, team changes, team termination, and employees joining and leaving the organization.

Moreover, the content management system improves accuracy relative to conventional systems. Specifically, as mentioned above, the content management system trains and retrains the expert selection model with updated data sources and feedback information. Because of this, in response to receiving an expert assistance query, the content management system can accurately identify a relevant expert based on the most up-to-date information. Indeed, the content management system can utilize data sources and datapoints created within the same day (even as soon as data is created) to identify the most recent and relevant expert with respect to a topic and thereby create an expert selection model that is near-real-time or real-time in identifying the most relevant person within an organization with respect to a topic. Thus, the content management system avoids the inaccuracies of conventional systems that arise in the face of static and rarely updated information.

Additionally, the expert selection model allows the content management system to identify topics at fine granularity and without respect to predefined topics. Indeed, the expert selection model is trained to identify relationships of any topic and individual, thus allowing the content management system to identify experts at a level that conventional systems simply cannot provide. Because the expert selection model is trained with various data sources, and because those data sources contain data at a fine-level of granularity, the expert selection model can be used to identify an expert of very minor or nuanced expert areas within an organization, thus improving the usefulness and accuracy of the content management system.

Additionally, the content management system improves efficiency relative to conventional systems. For example, the content management system avoids the inefficiencies and resource waste of conventional system by training the expert selection model, such that, when queried, the expert selection model accurately identifies a most relevant expert. The content management system further avoids the resource waste of conventional systems by providing relevant emails, documents, code, and so forth associated with the identified expert such that the querying user can potentially educate him or herself (e.g., thus avoiding additional computing resource use), and/or 2) ensuring that additional resources are not wasted by the querying user attempting to contact the wrong person (e.g., an incorrectly identified expert).

Furthermore, the content management system provides these advantages and benefits in connection with an efficient graphical user interface that receives a single user input (e.g., an expert assistance query) in order to provide information associated with one or more experts related to the key topic. As such, the content management system avoids the onerous requirements of conventional systems—namely, that a user of a conventional system generally has to interact with multiple data displays and send multiple communications to identify a person who might be knowledgeable with regard to a particular topic. This means that the graphical user interface generated by the content management system particularly improves the efficiency of using mobile devices, where changing displays and performing multiple user interactions is difficult because of smaller display screen sizes.

As illustrated by the foregoing discussion, the present disclosure utilizes a variety of terms to describe features and advantages of the content management system. Additional detail is now provided regarding the meaning of such terms. For example, as used herein, the terms “expert” and “most knowledgeable person” refer to a content management system user who is associated with one or more data sources indicating he or she is knowledgeable with regard to a certain topic. To illustrate, an expert or most knowledgeable person with regard to a particular topic is a content management system user who is connected with and/or authored one or more of digital documents, computer code, emails, electronic messages, digital presentations, digital media, and/or other data that address the particular topic above what other users of the content management system have contributed.

Additionally, the term “key topic” refers to a main or substantial topic extracted from an expert assistance query. In particular, the term “key topic” can include a word or phrase directed to a particular part of speech that indicates a topic with regard to which a person might be an expert. To illustrate, a key topic can include a complete sentence (e.g., “I need help finding someone who knows about search functions”), a phrase (e.g., “search functions”), or word (e.g., “searching”).

As used herein, an “expert assistance query” refers to a query (e.g., text for voice) received by the content management system via a dedicated display from which a key topic may be extracted. To illustrate, in at least one embodiment, the content management system receives an expert assistance query in the form of user input text via a graphical user interface on a client device. Additionally, as used herein, an “prior expert assistance query” refers to a previously received expert assistance query. For example, in at least one embodiment, the content management system efficiently leverages past successful expert identifications to quickly respond to a query. Thus, in at least one embodiment, the content management system stores prior expert assistance queries and their corresponding identified experts to provide in response to receiving the same or similar queries.

As mentioned, the content management system can utilize an expert selection model to accurately identify an expert in response to receiving an expert assistance query. As used herein, the term “model” refers to a machine learning model that can be tuned (e.g., trained) based on inputs to approximate unknown functions. In particular, the term model can include an architecture of interconnected artificial neurons (or layers) that communicate and learn to approximate complex functions and generate outputs based on a plurality of inputs provided to the model. In particular, a model includes a computer-implemented algorithm that implements deep learning techniques to analyze input (e.g., training input encoded as an input vector) to make identification predictions and that improves in accuracy by comparing generated identification predictions against ground truth data and modifying internal parameters for subsequent predictions. In some embodiments, a model can employ supervised learning, while in other embodiments a model can employ unsupervised learning or reinforced learning. Examples of models include multilayer perceptron networks, deep convolutional neural networks, generative adversarial neural networks, and recurrent neural networks. As used herein, the term “multilayer perceptron network” refers to a type of feedforward artificial neural network that includes at least three layers of nodes: an input layer, one or more hidden layers (e.g., perceptron layers), and an output layer. In one or more embodiments, a multilayer perceptron network performs analytical tasks on sequential elements and analyzes individual elements based on computations (e.g., latent feature vectors) from other elements.

Relatedly, the term “train” refers to utilizing information to tune or teach a model. The term “training” (used as an adjective or descriptor, such as “training data”) refers to information or data utilized to tune or teach the expert selection model. In some embodiments, the content management system trains one or more of the above-described models to generate accurate expert identification predictions based on respective training data. For example, as used herein, training data can include training inputs and corresponding training markers. In at least one embodiment, a training marker includes a ground truth associated with a corresponding training input. To illustrate, the content management system can train expert selection model with training data source inputs. For instance, a training data source input may include a digital document authored by a particular user and focused on a particular topic. The corresponding ground truth data associated with the training data source input can include the particular user who authored the digital document.

As used herein, “data source inputs” refer to a range of data inputs that are user-authored and include an indication of one or more key topics. For example, data source inputs can include, but are not limited to, emails, text messages, instant messages, newsfeeds, computer code, digital documents, digital presentations, digital calendars, organizational data, and digital media.

As used herein, “online mode” refers to an operational mode wherein the content management system as received an expert assistance query and is identifying a corresponding expert or most knowledgeable person. Similarly, “offline mode” refers to an operational mode wherein the content management system is accessing data source inputs and training and/or retraining the expert selection model based on the data source inputs. In one or more embodiments, the content management system may operate toggle into offline mode intermittently in response to determining that a threshold amount of time has passed since the last time the expert selection model was retrained, or in response to determining that new data source inputs exist that should be included in the expert selection model. Additionally or alternatively, the content management system may utilize copies of the expert selection model in order to run in online and offline mode concurrently.

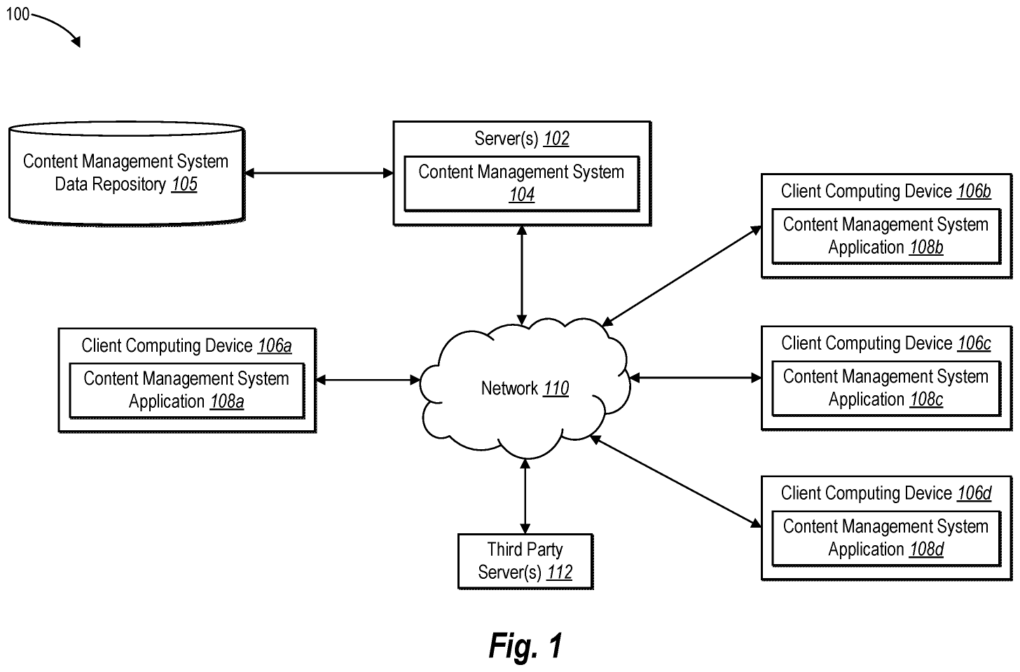

FIG. 1 is a schematic diagram illustrating an example system 100 wherein content management system 104 operates. As illustrated in FIG. 1, system 100 includes server(s) 102 including content management system 104 and associated with content management system data repository 105. Furthermore, example system 100 also includes client computing devices 106a, 106b, 106c, and 106d on which content management system applications 108a, 108a, 108c, and 108d are installed, respectively. As shown in FIG. 1, system 100 can also include third party server(s) 112.

In at least one embodiment, client computing devices 106a-106d and server(s) 102 are communicatively coupled across network 110. Although FIG. 1 illustrates a particular arrangement of client computing devices 106a-106d, server(s) 102, and network 110, various other arrangements are possible. For example, client computing devices 106a-106d may directly communicate with server(s) 102, bypassing network 110. Additionally, in one or more embodiments, any of client computing devices 106a-106d may not include content management system application 108a-108d, respectively, but rather may utilize the features of content management system 104 via a native application or web application.

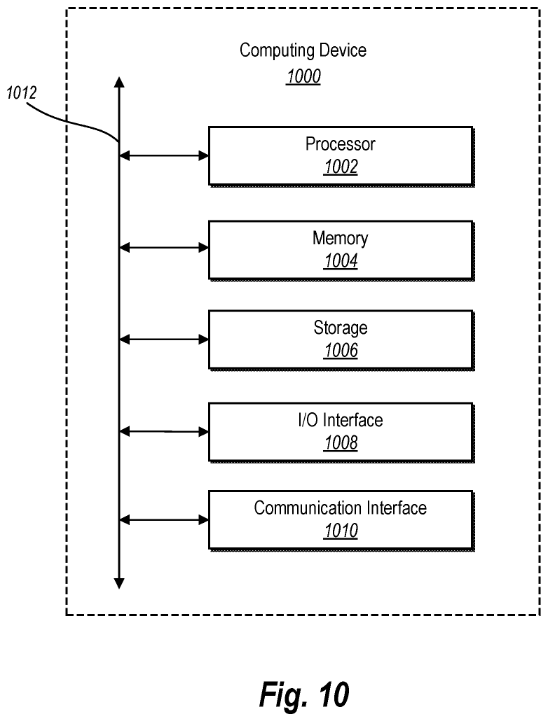

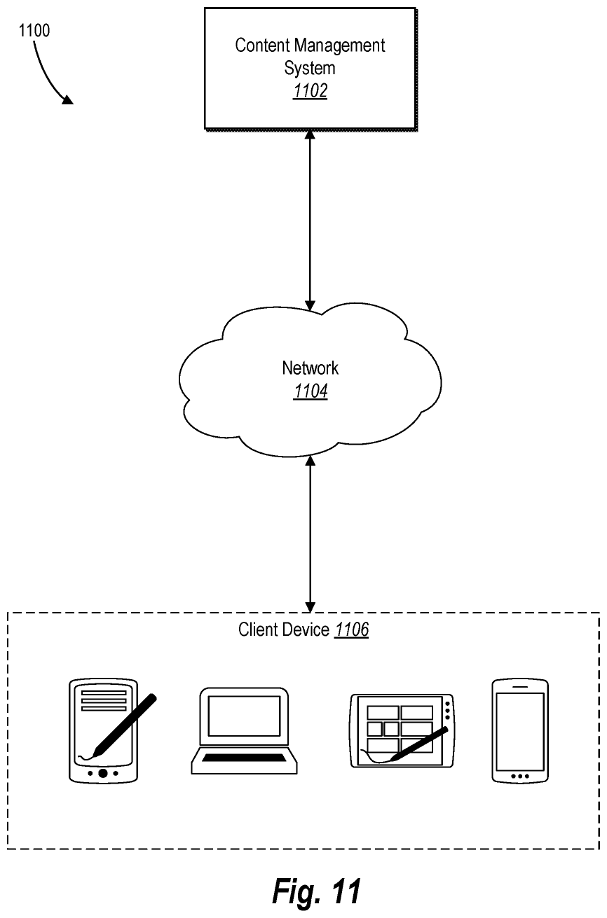

Although one or more embodiments are described herein as including client computing devices 106a-106d (e.g., smartphones, smart wearables), in additional embodiments, content management system 104 can operate in combination with any type of client computing device. For example, in an additional embodiment, rather than including a smart phone, system 100 can include a client computing device such as a laptop, desktop, tablet, wearable, etc. Additional examples and features of client computing devices are described below with reference to FIGS. 10 and 11.

Client computing devices 106a-106d and server(s) 102 may communicate using any communication platform or technology suitable for transporting data and/or communication signals. For example, client computing devices 106a-106d and server(s) 102 may communicate via any known communication technologies, devices, media, and protocols supportive of remote data communications, examples of which are described below with respect to FIGS. 10 and 11. In addition, in certain embodiments, client computing devices 106a-106d may communicate via network 110 with server(s) 102. Network 110 may be any suitable network over which client computing devices 106a-106d may access server(s) 102, or vice versa. Network 110 is discussed in more detail below with regard to FIG. 11.

As shown in FIG. 1, server(s) 102 includes content management system 104. In one or more embodiments, content management system 104 provides remote content storage to client computing devices 106a-106d (e.g., cloud storage) and enables users to identify experts across an organization. For example, a user with an account associated with content management system 104 can use a client device 106 to upload various types of digital content items (e.g., digital photographs, digital videos, PDF files, word processing files, etc.) to content management system 104. In at least one embodiment, content management system 104 organizes and stores uploaded digital content items within content management system data repository 105 for the user's later viewing and possible download. Additional details with respect to the content management system 104 are provided below with reference to FIG. 11.

Also further shown in FIG. 1, and as mentioned above, client computing devices 106a-106d include content management system applications 108a-108d, respectively. It will be understood that for the purpose of explanation herein, client computing device 106a is associated with expert assistance querier with regard to a particular topic, while client computing devices 106b, 106c, and 106d are associated with other content management system users who are potential experts relative to a topic. In one or more embodiments, content management system application 108 can be a native application on a client computing device 106 or a network application. In one or more embodiments, content management system application 108 is an Internet browser that accesses the content management system 104. Content management system applications 108a-d can provide one or more graphical user interfaces that enable a user to use and/or access content management system 104. For example, content management system application 108a can provide one or more interactive graphical user interfaces on a display of client computing device 106a that allow a user to cause content management system 104 to generate and provide a collection content item. In addition, content management system application 108a can provide one or more interactive graphical user interfaces on a display of client computing device 106a that enable the user to cause client computing device 106a to communicate with content management system 104 to upload digital content items, view digital content items, share digital content items, download digital content items, and so forth.

As further shown in FIG. 1, the system 100 includes third party server(s) 112. As mentioned above, content management system 104 enables the inclusion of data source inputs that are not located within content management system 104, but rather are located on third party server(s) 112. In one or more embodiments, third party server(s) 112 can be a web server, a social network, a file server, a communication server (e.g., IM, text, email) or any other type of remotely accessible computing device. Accordingly, content management system 104 can communicate with third party server(s) 112 over network 110.

As will be understood based on the disclosure herein, various functions and processes of content management system 104 can be located on server(s) 102, client computing devices 106a-d, or both server(s) 102 and client computing devices 106a-d. In some embodiments, content management system 104 on server(s) 102 cooperates with content management system application 108a-d on client computing device 106a-d to provide the functions and features described herein. Alternatively, the functions and features may be performed solely on client computing device 106a-d or solely on server(s) 102 as a particular application of content management system 104 requires.

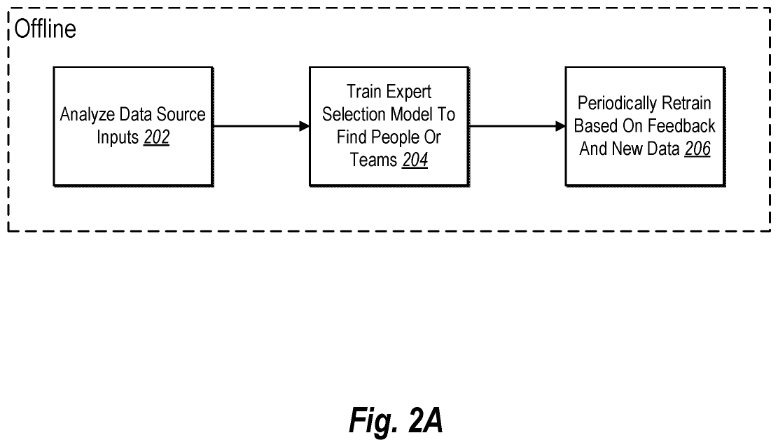

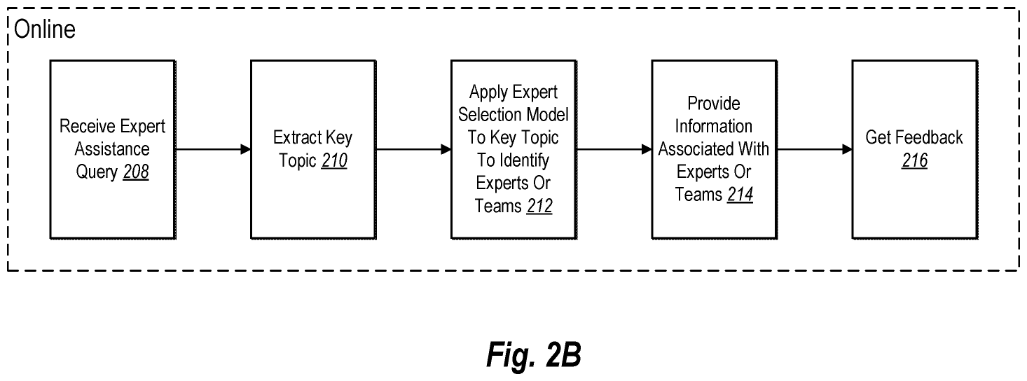

FIGS. 2A and 2B illustrate a broad overview of the features and functionality of content management system 104, as described herein. For example, as shown in FIG. 2A, content management system 104 can analyze data source inputs (202). In one or more embodiments, content management system 104 accesses data source inputs including, but not limited to, emails, electronic messages, digital documents and presentations, calendar information, organizational information, social networking information, digital media, and other data. Content management system 104 can further analyze the accessed data source inputs for keywords and topics, and index the accessed data source inputs according to one or more authors (e.g., authoring users) associated with each data source input.

Content management system 104 can further utilize the accessed data source inputs to train an expert selection model (204). For example, content management system 104 can utilize the data source inputs and associated author information to train the expert selection model to output one or more predicted experts in response to receiving an expert assistance query. More specifically, in response to receiving an expert assistance query, the trained expert selection model can extract one or more key topics from the expert assistance query, generate an input vector based on the one or more key topics, and output a predicted expert user associated with the one or more key topics.

Moreover, content management system 104 can periodically retrain the expert selection model (206). For example, in response to user feedback and detected updates to input data sources, content management system 104 can retrain the expert selection model in the same manner as mentioned above. More specifically, content management system 104 can receive user feedback indicating an identified expert is correct or incorrect. Content management system 104 can utilize this feedback to retrain the expert selection model. Further, content management system 104 can determine that there are input data source updates and/or that a threshold amount of time has passed since the last retraining of the expert selection model, and then retrain the expert selection model.

As further illustrated in FIG. 2B, content management system 104 can receive an expert assistance query (208). For example, content management system 104 can receive an expert assistance query via content management system application 108 on client computing device 106. Content management system 104 can receive the expert assistance query as a full sentence (e.g., “Please help me understand encryption”), a sentence fragment (e.g., “understand encryption”), or keyword (e.g., “encryption”).

In response to receiving the expert assistance query, content management system 104 can extract one or more key topics (210) from the expert assistance query. For example, utilize various key topic extraction techniques to extract a key topic including one or more of a noun, a verb, or another part of speech that is indicative of a particular topic that the querying user might want to understand in more depth.

With the key topic, content management system 104 can apply the trained expert selection model to the key topic in order to identify an expert and/or team associated with the expert (212). For example, as mentioned above, in response to receiving a key topic from an expert assistance query, the trained expert selection model can output a predicted expert associated with the key topic. In at least one embodiment, the trained expert selection model outputs the identification of a user who is most likely to be the most knowledgeable person relative to the key topic within the same organization (e.g., company, team, department) as the querying user.

Content management system 104 can further provide information associated with the identified expert and/or team (214). For example, content management system 104 can provide contact information associated with the identified expert (e.g., email address, phone number, chat handle). Additionally, content management system 104 can provide one or more digital content sources associated with both the identified expert and the key topic. For example, content management system 104 can utilize the previously generated index to identify digital content sources authored by or associated with the identified expert, and then analyze the identified digital content sources for those that correlate with the key topic.

In order to further train the expert selection model, content management system 104 can solicit feedback relative to the identified expert (216). For example, in response to detecting a contact between the querying user and the identified expert (e.g., a detected selection of an email address, etc.), and/or after a threshold amount of time from providing the identified expert to the querying user, content management system 104 can request feedback via a display and/or notification within content management system application 108 on client computing device 106 asking the querying user to confirm whether the identified expert was correct, helpful, available, and so forth. In one or more embodiments, content management system 104 can utilize the received feedback to further retrain the expert selection model for increased speed and accuracy.

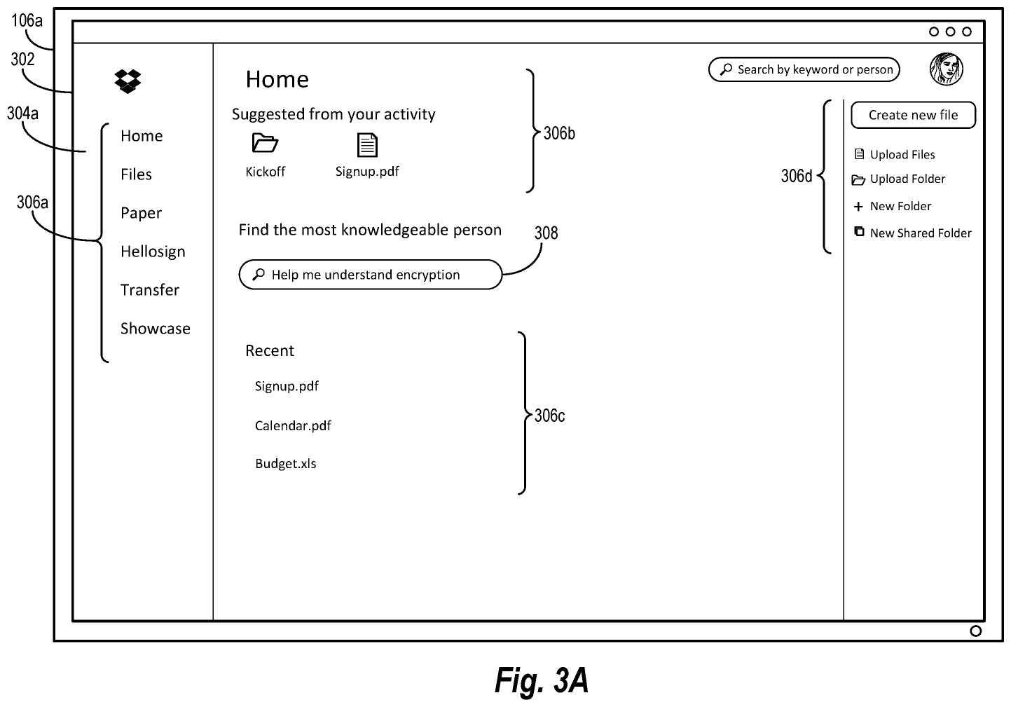

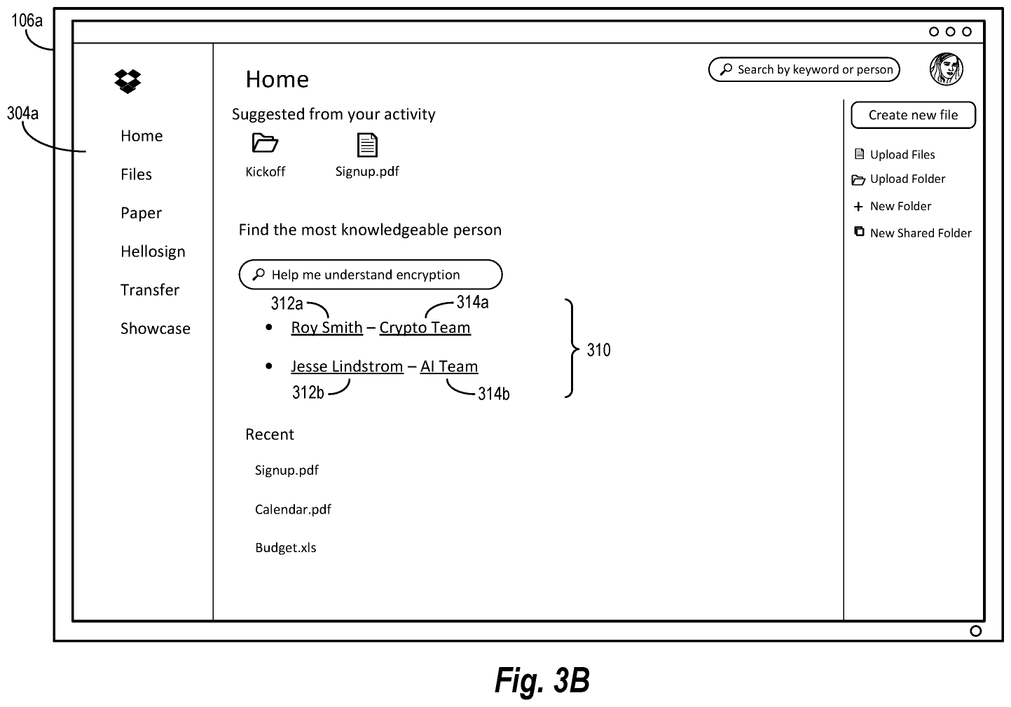

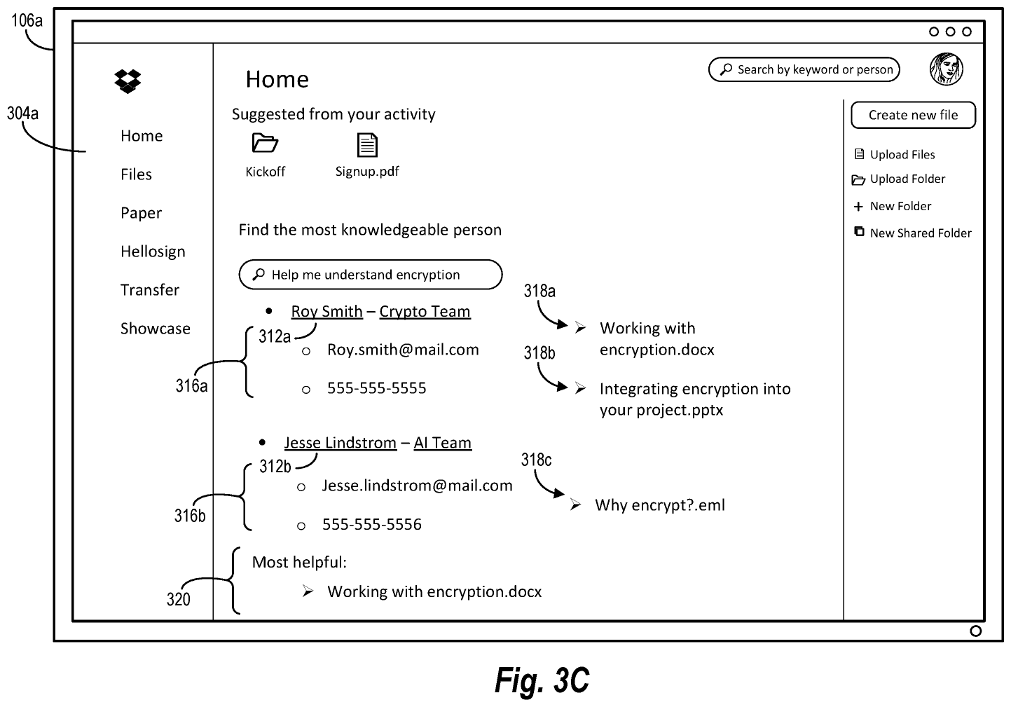

As will be described in more detail below, content management system 104 can generate, modify, and provide one or more graphical user interfaces in order to receive expert assistance queries and provide expert information. FIGS. 3A-5B and the description that follows illustrate various example embodiments of graphical user interfaces and features in accordance with the features and functions of content management system 104 described herein.

For example, FIG. 3A illustrates a home screen 304a of content management system 104 on a display 302 of client computing device 106a. As shown, home screen 304a includes various controls 306a-306d to assist in navigating content management system 104, accessing recent files, uploading content items, and organizing stored content items. As further shown in FIG. 3A, home screen 304a also includes a text box 308 for receiving an expert assistance query. For example, content management system 104 can receive an expert assistance query entered by a user via text box 308. In alternative embodiments, content management system 104 can receive an expert assistance query via home screen 304a in other ways including, but not limited to, other types of display controls, voice recognition, image analysis (e.g., via a camera of client computing device 106a), tactile feedback (e.g., a pressure variable input on a touch screen, a tilt or shake), or any other type of input.

As discussed above, in response to receiving an expert assistance query (e.g., “help me understand encryption”) via text box 308, content management system 104 can generate an input vector based on one or more key topics (e.g., “encryption”) extracted from the expert assistance query. Content management system 104 further applies the trained expert selection model to the input vector and receives a predicted expert associated with the key topic. Content management system 104 can repeatedly apply the trained expert selection model to the input vector to receive additional predicted experts associated with the key topic. Accordingly, in one or more embodiments the expert selection model can provide multiple candidates for an expert corresponding to the key topic and the system 104 can select which experts to provide (e.g., by a ranking with respect to relevance to the key topic).

Based on identifying one or more experts, the system 104 can provide the experts names for display on the client device 106a. For example, as shown in FIG. 3B, the content management system 104 can provide an expert results section 310 within home screen 304a including expert names 312a, 312b. In addition to providing the identified experts 312a and 312b, content management system 104 can also provide additional information associated to the identified experts. For example, FIG. 3B. illustrates the identified expert names 312a and 312b are presented along with their associated teams 314a, 314b. In at least one embodiment, content management system 104 provides expert names 312a, 312b and associated teams 314a, 314b as selectable hyperlinks.

In response to receiving an indication of a selection of any of expert names 312a, 312b and/or associated teams 314a, 314b, content management system 104 can provide additional information. For example, as shown in FIG. 3C, in response to receiving an indication of a selections of expert names 312a, 312b, content management system 104 can provide contact information 316a, 316b associated with respective expert names 312a, 312b. In one or more embodiments, contact information 316a, 316b can include an email address, a phone number, a chat handle, a virtual business card, or any other type of contact information. In at least one embodiment, content management system 104 provides one or more of each contact information to be selectable such that in response to a detected selection of a contact information (e.g., an email address), content management system 104 can initialize an associated application (e.g., an email application) in association with the contact information an proceed to contact the recommended expert. Thus, in just one or two user interactions, the content management system identifies an expert and facilitates direct communication with the identified expert.

Additionally, as shown in FIG. 3C, content management system 104 can also provide one or more data source inputs 318a, 318b, 318c associated with the identified experts. For example, content management system 104 can identify data source inputs associated with each identified expert and then analyze the identified data source inputs with regard to how strongly each data source input correlates with the key topic extracted from the received expert assistance query. In one or more embodiments, content management system 104 can provide a threshold number of the most relevant data source inputs within home screen 304a. In at least one embodiment, content management system 104 provides data source inputs 318a-318c as selectable hyperlinks. In response to a detected selection of any data source input 318a-318c, content management system 104 can visualize the associated data source input within the web interface or can download the associated data source input for viewing in a corresponding application.

In one or more embodiments, content management system 104 may determine that the received expert assistance query is the same or similar to a prior expert assistance query (e.g., a previously received and processed expert assistance query). In response to determining that the received expert assistance query is the same or similar to a prior expert assistance query, content management system 104 can provide information identified in response to the prior expert assistance query. For example, as shown in FIG. 3C, in response to determining that the expert assistance query entered text box 308 is the same or similar to an existing assistance query, content management system 104 can provide information 320 that was indicated as helpful by a previous user who provided feedback associated with the prior expert assistance query. To illustrate, content management system 104 identified and provided data source input 318a (e.g., “working with encryption.docx”) to a previous user who queried, “information on encryption.” Content management system 104 then received feedback from that previous user indicating that data source input 318a was particularly helpful with regard to his or her query. Then, in response to receiving the similar expert assistance query, “help me understand encryption,” content management system 104 can provide data source input 318a with or without utilizing the expert selection model, as discussed above.

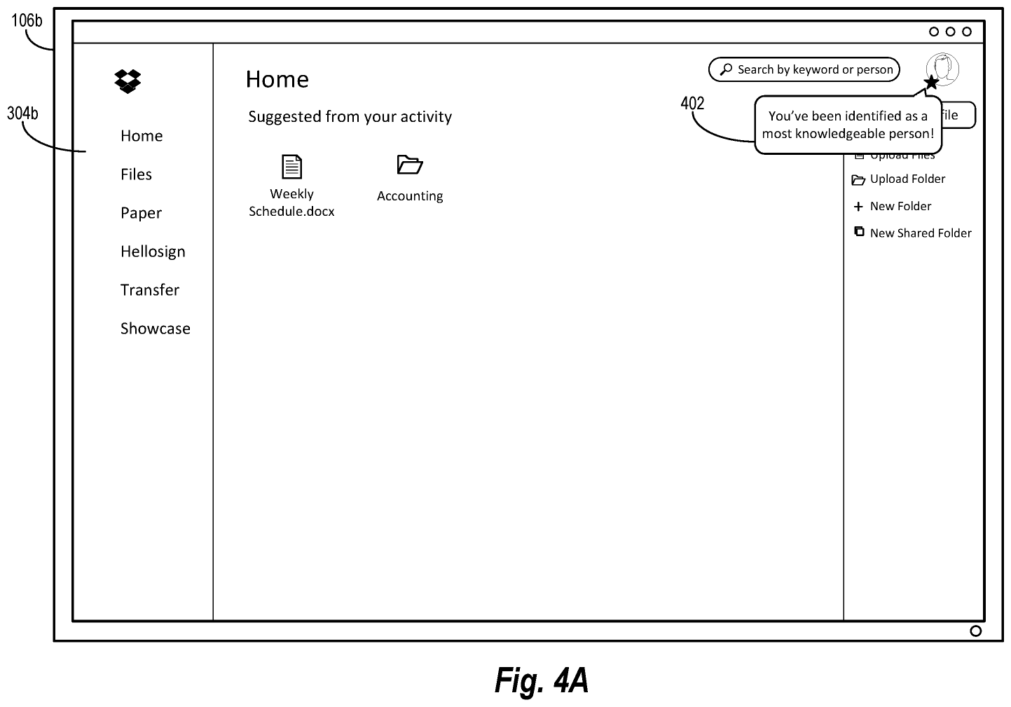

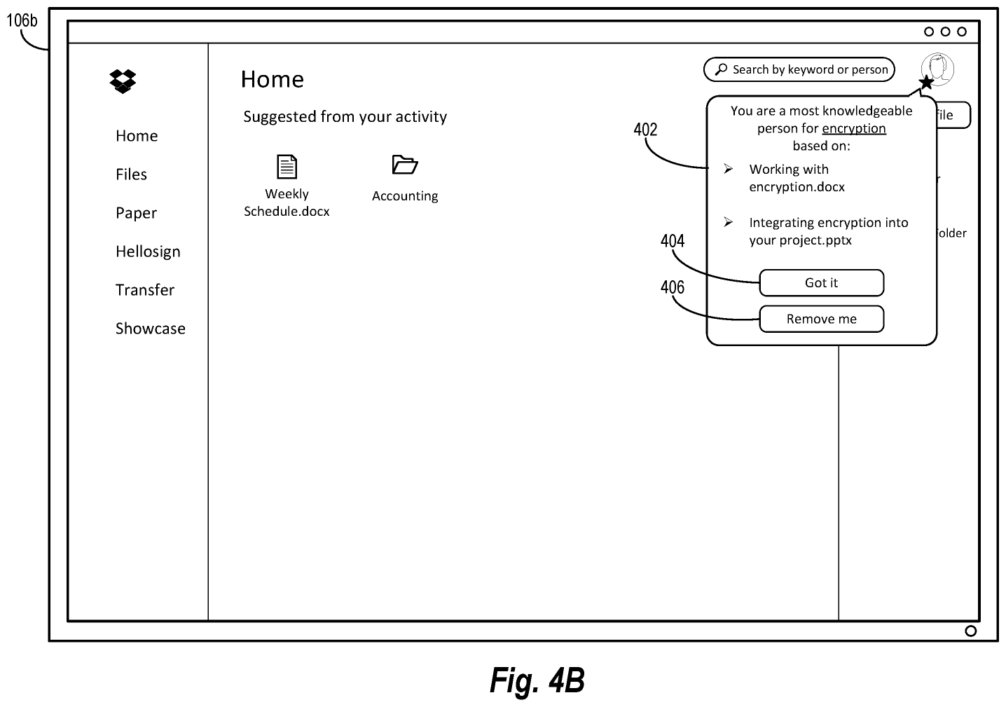

In one or more embodiments, content management system 104 can notify an identified expert that he or she has been identified with regard to a particular key topic. For example, as shown in FIG. 4A, in response to content management system 104 identifying the user associated with client computing device 106b as an expert, content management system 104 can generate and provide a notification 402 on home screen 304b displayed on client computing device 106b. Content management system 104 can generate notification 402 to include a first level of information (e.g., a simple notification), and can provide notification 402 when the user of client computing device 106b first opens home screen 304b.

In response to receiving an indication of a selection of notification 402, content management system 104 can provide additional information related to the expert identification. For example, as shown in FIG. 4B, content management system 104 can expand notification 402 to include a second level of information including, but not limited to, the key topic with regard to which the user of client computing device 106b has been identified as an expert (e.g., “encryption”), and one or more data source inputs authored by the user of client computing device 106b and responsive to the key topic. Accordingly, the content management system 104 can provide the topic for which the user was selected as an expert as well as some data source inputs that likely help generate the expert identification.

In at least one embodiment, content management system 104 can further improve the accuracy of the expert selection model by soliciting feedback with regard to an identified expert. For example, as shown in FIG. 4B, content management system 104 can include a “got it” or approval button 404 and a “remove me” or disapproval button 406 as part of expanded notification 402. In response to a detected selection of the approval button 404, content management system 104 can store training information indicating that the user of client computing device 106b has confirmed him or herself as an expert associated with the identified key topic. Conversely, in response to a detected selection of disapproval button 404, content management system 104 can store training information indicating that the user of client computing device 106b is not an expert associated with the identified key topic. Content management system 104 can further notify the querying user that the user of client computing device 106b was identified in mistake and should not be contacted with regard to the identified key topic. In addition, the system can provide the querying user with another recommended expert based on running the query through the updated expert selection model within the same notification that indicates the previously identified expert is not correct.

In at least one embodiment, the expanded notification 402 can further include an input option such that the user of the client computing device 106b can suggest one or more alternate experts. For example, in response to a detected selection of the disapproval button 404, the content management system 104 can include a text input box wherein the user of the client computing device 106b can input one or more alternate experts. In one or more embodiments, the content management system 104 can: 1) notify the one or more alternate experts that they have been identified as experts relative to the key topic, 2) utilize this additional feedback to further train the expert selection model, and/or 3) notify the querying user of the one or more alternate experts.

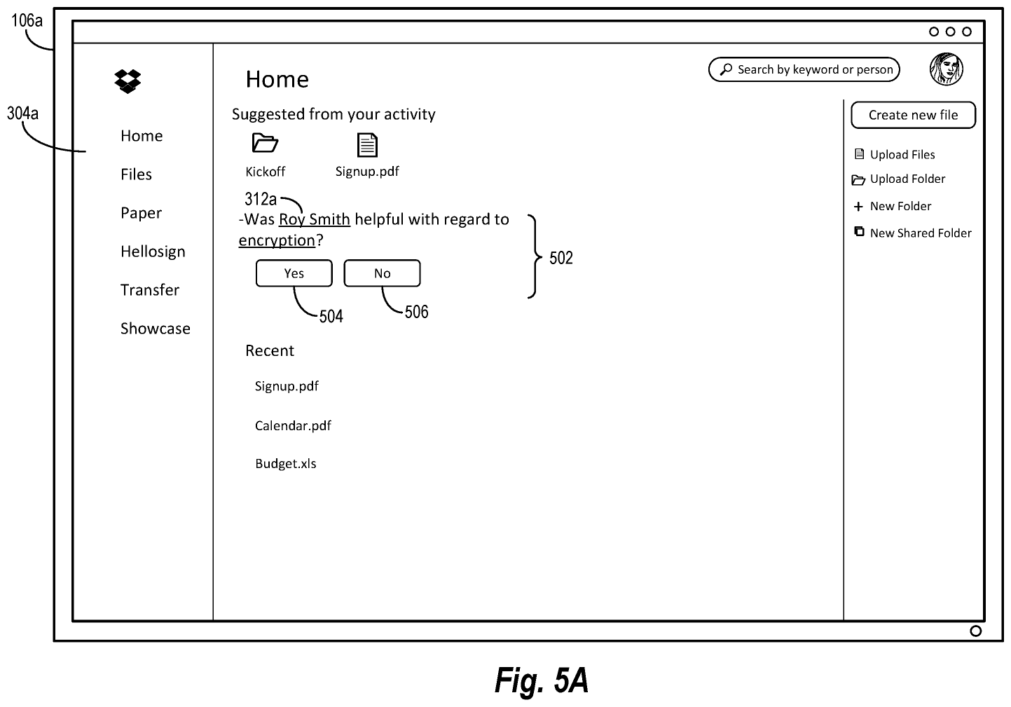

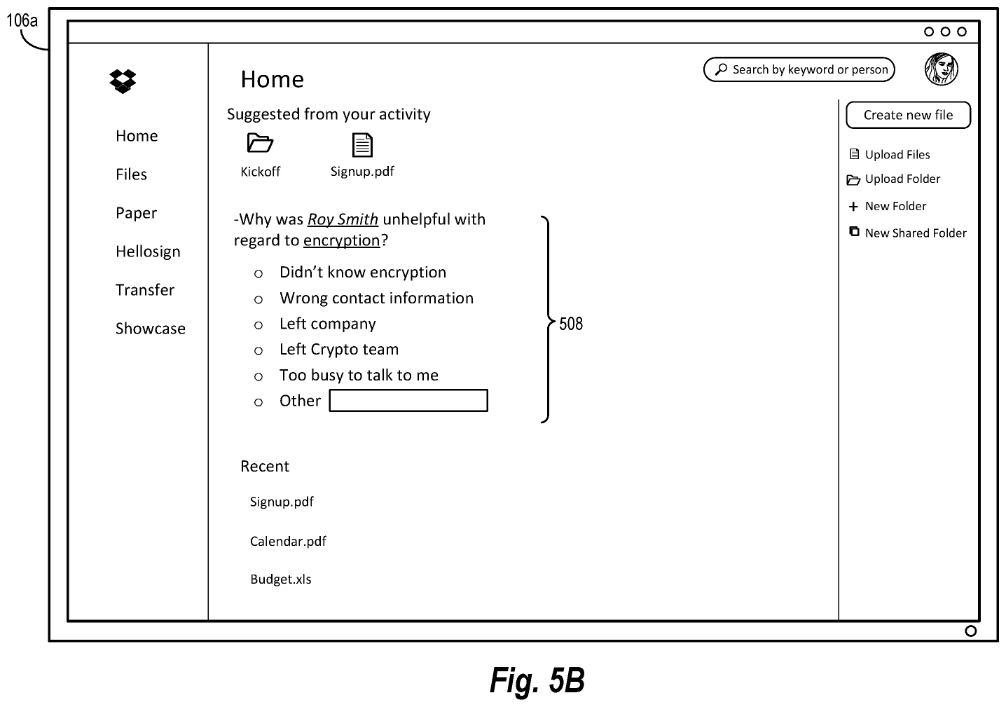

As just mentioned, content management system 104 can solicit feedback regarding expert identification in order to improve the accuracy and efficiency of the expert selection model. For example, as shown in FIGS. 5A and 5B, content management system 104 can solicit feedback from the querying user of client computing device 106a regarding a previous expert identification. For example, content management system 104 can detect an interaction with contact information 316a (e.g., as shown in FIG. 3C) in order to determine that the associated expert is one that the querying user (e.g., the user of client computing device 106a) has likely contacted. Thus, at some amount of time following an expert identification (e.g., as with FIGS. 3A-3C), content management system 104 can generate and provide a feedback section 502 inquiring whether a previously identified and likely contacted expert was helpful.

For example, content management system 104 can generate feedback section 502 to include an expert name 312a along with the key topic (e.g., “encryption”) with regard to which the expert (e.g., “Roy Smith”) was identified. Additionally, content management system 104 can include a yes button 504 and a no button 506 in feedback section 502. For example, in response to a detected selection of yes button 504, content management system 104 can store training information indicating that the identified expert was helpful with regard to the identified key topic. In response to a detected selection of no button 506, content management system 104 can store training information indicating that the identified expert was not helpful with regard to the identified key topic.

In one or more embodiments, in response to the detected selection of no button 506, content management system 104 can solicit further feedback. For example, as shown in FIG. 5B, content management system 104 can generate and provide radio buttons 508 in response to the detected selection of no button 506. As shown, content management system 104 can configure radio buttons 508 to refer to various options regarding why the identified expert was not helpful. In response to a detected selection of one of radio buttons 508, content management system 104 can store training information indicating why the identified expert was not helpful with regard to the identified key topic. In additional or alternative embodiments, content management system 104 can solicit feedback from the user of client computing device 106a in other ways. For example, content management system 104 can solicit feedback via a popup notification, an email, an SMS text message, a chat window, and so forth.

In at least one embodiment, it is possible that in determining that the identified expert was not helpful the querying user identified a different person as an expert with regard to the key topic. For example, the querying user may have contacted the identified expert, only to have the identified expert suggest another person as being more knowledgeable. Accordingly, in response to the detected selection of no button 506, the content management system 104 can provide an text input option (in addition to the radio buttons 508) wherein the user of the client computing device 106a can specify one or more alternate experts associated with the key topic.

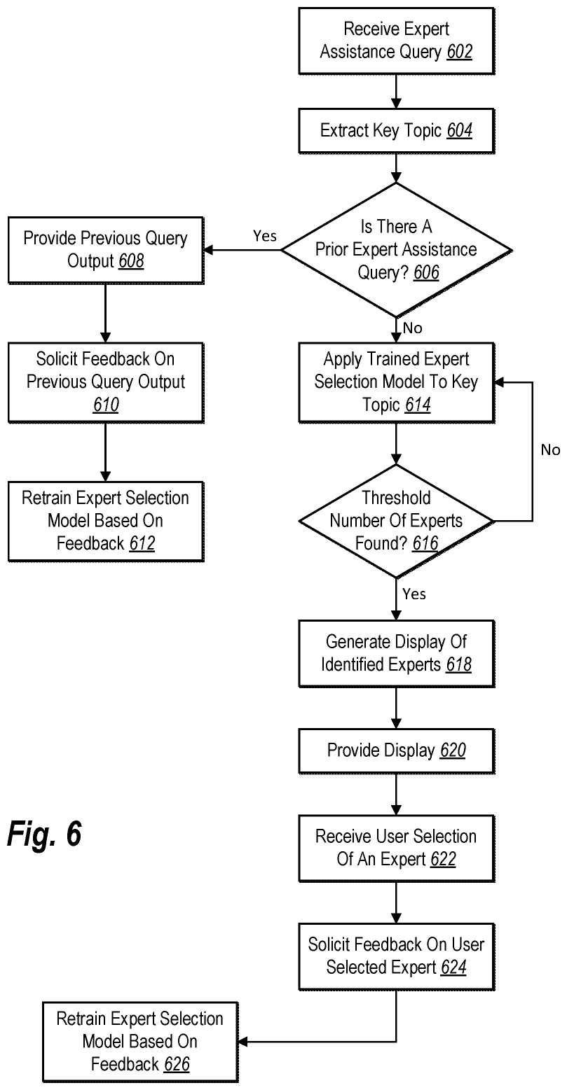

Additional detail is now provided in FIG. 6 with regard to the process by which content management system 104 identifies experts. For example, as shown in FIG. 6, content management system 104 can receive an expert assistance query (602). Specifically, as discussed above, content management system 104 can receive an expert assistance query via one or more display elements in a home screen of content management system application 108a on client computing device 106a. Alternatively, content management system 104 can receive the expert assistance query as spoken input, a touch gesture input, or any other type of appropriate input. Content management system 104 can receive the expert assistance query as a full sentence, a partial sentence, or a single word or phrase.

Content management system 104 can extract a key topic (604) from the received expert assistance query. For example, content management system 104 can extract a key topic from the received expert assistance query in any one of various ways. In one embodiment, content management system 104 can utilize a part-of-speech tagger to identify nouns within the expert assistance query. Content management system 104 can then determine the key topic based on the one or more identified nouns. In another embodiment, content management system 104 can additionally identify collocations (e.g., words following one another) within the expert assistance query to determine the key topic. In another embodiment, content management system 104 can further utilize parts of speech tags associated with the expert assistance query to identify common types of phrases within the expert assistance query (e.g., a noun-verb phrase), and determine the key topic based on the identified phrase. In yet another embodiment, rather than utilizing parts of speech tags, content management system 104 can convert the expert assistance query to a vector (e.g., using a function such as word2vec), and utilize the resulting vector as the key topic.

In order to save time and computing resources, as well as increase the accuracy of a response, prior to applying the expert selection model to the extracted key topic, content management system 104 can determine whether there is a prior expert assistance query (606). For example, in some embodiments, content management system 104 stores prior expert assistance queries along with any corresponding identified experts and expert information. In one or more embodiments, content management system 104 can determine that there is a corresponding prior expert assistance query based on determining that one of the prior expert assistance queries is either the same as or similar to the current expert assistance query. For example, content management system 104 can determine that a prior expert assistance query is similar to the current expert assistance query if both queries are directed to the same key topic, if both queries are directed to key topics that are linguistically related, and/or if both queries are within a defined range vector range when converted to vectors.

In response to determining that there is a prior expert assistance query that applies to the current expert assistance query (e.g., “yes”), content management system 104 can identify and provide the output associated with the prior expert assistance query (608). For example, as just mentioned, content management system 104 can store prior expert assistance queries and the prior identified expert information associated with those queries. Thus, content management system 104 can provide the output associated with the prior expert assistance query by providing the name and contact information for the expert identified in response to the prior expert assistance query. Content management system 104 can further provide data source inputs (e.g., emails, documents, computer code, digital presentations) associated with the identified expert and associated with the key topic. In one or more embodiments, by providing this previously identified information, content management system 104 efficiently avoids wasting computing resources in re-identifying an expert who was already identified in response to a similar query.

Additionally, in at least one embodiment, content management system 104 provides the previously identified expert and associated information if the prior expert assistance query was received within a threshold amount of time. For example, content management system 104 may provide the previously identified expert and associated information if the prior expert assistance query was received within a defined time period since the prior expert assistance query was received (e.g., two weeks), thereby avoiding potentially outdated information. For example, the content management system may only prior expert assistance query and identified expert information for a specified period of time, after which the content management system will use the expert selection model to identify an expert to make sure the identified expert is up-to-date. Furthermore, in at least one embodiment, content management system 104 may provide the previously identified expert associated with the prior expert assistance query only if feedback was received in association with the previously identified expert confirming that the expert was identified correctly.

After providing the previously identified expert and associated information, content management system 104 can solicit feedback on the provided data (610) and retrain the expert selection model based on the feedback (612). For example, and as will be discussed further below, content management system 104 can request confirmation from the querying users (e.g., the user who submitted the received expert assistance query) that the identified expert was correctly identified and/or that the additionally provided data source inputs were helpful. Content management system 104 can generate training data based on the received feedback and utilize the generated training data to retrain the expert selection model.

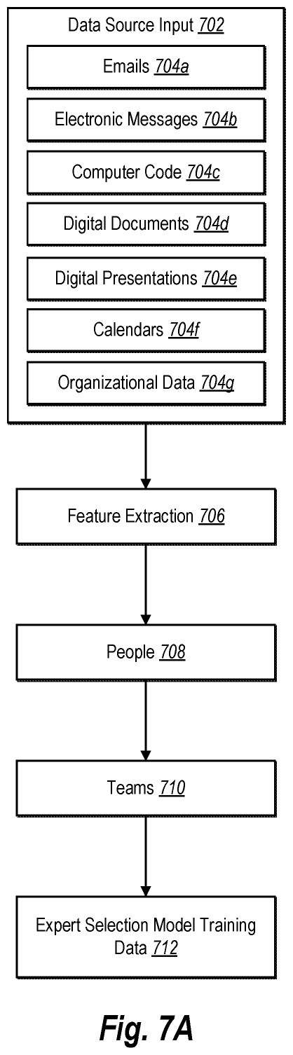

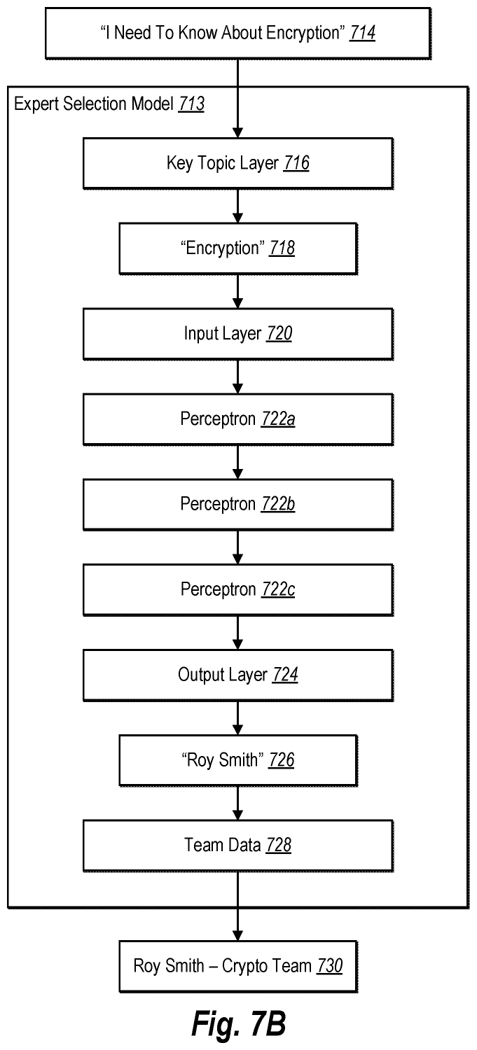

As further illustrated in FIG. 6, in response to determining that there is no prior expert assistance query (e.g., “no”), content management system 104 can apply the trained expert selection model to the extracted key topic (614). For example, as will be discussed further below with regard to FIGS. 7A and 7B, content management system 104 can generate an input vector based on the extracted key topic and provide the generated input vector to the trained expert selection model. Content management system 104 can further receive, from the trained expert selection model, a predicted expert associated with the key topic.

In one or more embodiments and depending on various factors, content management system 104 can identify more than one expert associated with a key topic extracted from an expert assistance query. For example, content management system 104 can determine to identify multiple experts in response to determining that there are high number of authors associated with relevant data source inputs. To illustrate, in an offline mode, content management system 104 can index data source inputs by key topics and authors. In at least one embodiment, content management system 104 can further score data source inputs based on a level of relevance in connection with the key topics therein. For example, content management system 104 can score a digital document with an overall topic of “encryption” higher than an email that mentions “encryption” in passing.

Thus, if there exist many data source inputs with different authors and with high scores associated the current key topic, content management system 104 may determine to identify more than one expert relative to the key topic. For example, content management system 104 can determine a threshold number of experts to identify by identifying a number that is proportionate to the number of data source inputs with scores in a top percentage of scores, or with scores above a predetermined number. In an alternative embodiment, content management system 104 can determine the threshold number based on a number of authors associated with data source inputs with top scores relative to the key topic.

In response to receiving an identified expert from the expert selection model, content management system 104 can determine whether the threshold number of experts have been found (616). If the threshold number of experts have not been found (e.g., “no”), content management system 104 can again apply the trained expert selection model to the key topic (614). For example, in at least one embodiment and during a threshold amount of time, the expert selection model outputs a particular expert only once. More specifically, if repeatedly applied to the same key topic within a threshold amount of time (e.g., 3 seconds), the expert selection model can first output to the top ranked expert, and then can output the second ranked expert, the third ranked expert, and so forth. Thus, content management system 104 can repeatedly apply the trained expert selection model to the key topic until the threshold number of experts are found.

Additionally or alternatively, the expert selection model can output the threshold number of experts at the same time. For example, in at least one embodiment, the content management system 104 can train the expert selection model to output a given number of experts, where the given number is part of the input vector. Thus, in response to receiving an input vector specifying a threshold number of experts (in addition to other information), the content management system 104 can receive the threshold number of experts from the expert selection model.

Once content management system 104 determines that the threshold number of experts have been found (e.g., “yes), content management system 104 can generate a display of the identified experts (618). For example, as illustrated above with regard to FIGS. 3A-3C, content management system 104 can generate an expanding display by identifying contact information associated with the identified experts, teams associated with the identified experts, and relevant data source inputs associated with the identified experts. Content management system 104 can generate the display to include selectable display options directed to the one or more identified experts, teams associated with the identified experts, and one or more relevant data sources associated with the identified experts.

Content management system 104 can further provide the generated display (620) to client computing device 106a associated with the querying user. For example, content management system 104 can provide the generated display to client computing device 106a via content management system application 108a installed thereon. Content management system 104 can provide the generated display for inclusion as part of a home screen, as part of a notification, as part of a dedicated window, or similar.

Content management system 104 can also receive a user selection of an expert (622). For example, content management system 104 can detect a user interaction with any of the provided information within the generated display. More specifically, content management system 104 can detect a user interaction with a provided content information hyperlink associated with a particular expert, a data source input hyperlink associated with a particular expert, and/or a team hyperlink associated with a particular expert. In response to detecting the user interaction, content management system 104 can begin a process thread associated with the querying user and the expert associated with the selected display element.

At some point following the detected user interaction, content management system 104 can solicit feedback related to the associated expert (624). For example, as mentioned above, in order to optimize the accuracy of the expert selection model, content management system 104 can generate training data based on feedback as to whether an identified expert is correct or not. Thus, and as illustrated in FIGS. 5A and 5B above, content management system 104 can solicit feedback from the querying user as to whether the identified expert (who the querying user likely contacted as indicated by the detected user interaction with the expert information) was correct and helpful. As will be discussed in greater detail below with reference to FIGS. 7A and 7B, and based on the received feedback, content management system 104 can retrain the expert selection model (626) for greater accuracy in identifying experts.

As discussed above, content management system 104 utilizes an expert selection model in addition to other indexing and algorithms to identify an expert associated with a particular key topic. FIGS. 7A and 7B provide additional information with regard to the architecture and training of the expert selection model and other processes by which content management system 104 identified experts. For example as shown in FIG. 7A, content management system 104 indexes data source inputs and experts, and trains the expert selection model with data source inputs 702. As shown, data source inputs 702 can include, but are not limited to, emails 704a, electronic messages 704b, computer code 704c, digital documents 704d, digital presentations 704e, calendars 704f, and organizational data 704g. In one or more embodiments, each of the data source inputs 702 is associated with attributes and features including, but not limited to, one or more authors, a creation timestamp, a received timestamp, an accessed timestamp, an originating client device, a receiving client device, a number of words and/or characters, a file type, a file size, and a content summary. Additionally, content management system 104 can access data source inputs 702 from a data repository that is internal to an organization (e.g., an company server), and/or external to the organization (e.g., a third-party server on which the organization has an account).

As discussed above, content management system 104 generates training data for expert selection model 713 utilizing data source inputs 702. In order to generate the training data, and as further shown in FIG. 7A, content management system 104 performs a feature extraction (706) on the accessed data source inputs 702. For example, as just mentioned, each of data source inputs 702 is associated with explicit features such as timestamps, authors, file types, summaries, and so forth. In one or more embodiments, content management system 104 can extract explicit features by analyzing metadata associated with each of data source inputs 702, by analyzing content associated with each of data source inputs 702, by analyzing headers associated with each of data source inputs 702, and by analyzing file information associated with each of data source inputs 702.

Additionally, data source inputs 702 can be associated with abstract features. For example, content management system 104 can extract a vector representation of a particular data source input as an abstract feature associated with that data source input. To illustrate, a vector representation of a data source input may be a set of numbers that represents the data source input in its entirety. In one or more embodiments, content management system 104 can extract a vector representation of a data source input utilizing a vector generating algorithm such as word2vec.

After extracting explicit and abstract features from each of data source inputs 702, content management system 104 further generates the expert selection model training data by aggregating the extracted features per person (708). For example, because the expert selection model is directed to identifying an expert with regard to a particular key topic, the expert selection model training data should include, for each person in an organization (e.g., in a company, a team, a project), all key topics with which a person is associated (e.g., as indicated by the extracted features of data source inputs 702). Accordingly, content management system 104 can aggregate the extracted features per person by building a graph, linked list, flat file, or other data representation wherein each person in the organization is computationally linked to every extracted feature that is associated with that person. For example, a person may be associated with a feature when that person authored the corresponding data source input from which the feature was extracted, when that person received the corresponding data source input from which the feature was extracted, and/or when that person edited the corresponding data source input from which the feature was extracted.

Optionally, content management system 104 can further enhance the expert selection model training data by aggregating the analyzed people within the organization into teams (710). For example, in some embodiments, content management system 104 can provide team information in association with an identified expert so as to provide the querying user with additional people who may be knowledgeable regarding a key topic. Thus, content management system 104 can aggregate people into teams (710) based on one or more extracted features associated with one or more people (e.g., an email chain may indicate additional email recipients who are team members, a digital document may be authored by a team of people). Additionally, content management system 104 can aggregate people into teams based on organizational data that indicates a formal team structure within the organization. Content management system 104 can perform this aggregation by modifying a graph, linked list, flat file, or other data representation to include the team information.

Finally, after performing these extractions and aggregations, content management system 104 generates the expert selection model training data 712. For example, content management system 104 can generate the expert selection model training data 712 by utilizing the data representation of features aggregated by people and teams to identify training data source inputs and corresponding training users. More specifically, content management system 104 can generate training input pairs, where each pair includes a training data source input (e.g., an extracted feature) and a corresponding training user (e.g., the ground truth user within the organization associated with that extracted feature). Additionally, in at least one embodiment, content management system 104 can further enhance the expert selection model training data 712 by including additional training input pairs including a training data source input (e.g., an extracted feature) and a corresponding training team (e.g., the team associated with the ground truth user associated with the extracted feature).

In one or more embodiments, content management system 104 can utilize expert selection model training data to train an expert selection model. For example, content management system 104 can train the expert selection model by providing a training data source input (e.g., an extracted feature) from expert selection model training data 712 to expert selection model. The expert selection model can analyze the training data source input to extract a key topic and output a predicted expert. Content management system 104 can compare the predicted expert to the training user that corresponds to the training data source input (e.g., the ground truth user associated with the corresponding extracted feature). Based on the comparison, content management system 104 can modify parameters of the expert selection model to reduce a measure of loss. In one or more embodiments, content management system 104 repeats this process with all pairs in expert selection model training data 712 until conversion happens (e.g., loss does not further decrease). For example, content management system 104 can stop training before overfitting occurs by observing the loss on a validation set and stopping training at the minimized validation loss. As mentioned above with regard to FIG. 2A, content management system 104 can train the expert selection model while in an offline mode (e.g., not in response to a received expert assistance query).

After training the expert selection model, content management system 104 can apply the trained expert selection model to an expert assistance query to identify an expert corresponding to a key topic from the expert assistance query. FIG. 7B and the corresponding description provide additional information with regard to an example architecture associated with the expert selection model. For example, as shown in FIG. 7B expert selection model 713 includes multiple layers, each of which will now be discussed in greater detail.

For instance, in response to receiving expert assistance query 714 (e.g., “I need to know about encryption”), expert selection model 713 can activate a key topic layer 716. In one or more embodiments, key topic layer 716 serves to extract one or more key topics from an expert assistance query. As discussed above, key topic layer 716 can extract key topics from expert assistance query 714 by utilizing a part-of-speech tagger to identify a noun, or a sequence of parts of speech indicating a key topic. For example, key topic layer 716 can extract key topic 718 (e.g., “encryption”) from expert assistance query 714. Additionally or alternatively, key topic layer 716 can convert expert assistance query 714 to a vector representation (e.g., using word2vec or similar).

Next, expert selection model 713 can pass the extracted key topic to input layer 720. In one or more embodiments, input layer 720 generates an input vector. Input layer 720 can generate the input vector by parsing the received key topic, or by otherwise configuring or converting the received key topic into a format suitable for provision to additional layers of expert selection model 713.

In one or more embodiments, input layer 720 can feed the generated input vector to one or more perceptron layers 722a, 722b, 722c. For example, in at least one embodiment, each perceptron layer 722a-722c includes multiple nonlinearly-activating nodes and are fully connect. More specifically, each node in one perceptron layer (e.g., perceptron layer 722a) connects with a certain weight to every node in a following perceptron layer (e.g., perceptron layer 722b). Furthermore, nodes in each perceptron layer may be organized bi-directionally such that half the nodes in a perceptron layer are organized ‘forward,’ or in a sequence over increasing sequence instances, while the other half of the nodes are organized ‘backward,’ or in a sequence over decreasing sequence instances. Utilizing this organization, each perceptron layer 722a-722c can simultaneously utilize content information from the past and future of the current sequence instance to inform output layer 724 by passing latent feature vectors of previous perceptron layers to subsequent perceptron layers.

As further shown in FIG. 7B, expert selection model 713 can further include output layer 724. In one or more embodiments, output layer 724 can generate a final expert prediction (e.g., expert prediction 726—“Roy Smith”), based on one or more results of perceptron layers 722a-722c. For example, output layer 724 can generate expert prediction 726 by translating, decrypting, or otherwise transforming results of perceptron layers 722a-722c. Additionally or alternatively, output layer 724 can generate expert prediction 726 by comparing results of perceptron layers 722a-722c against organizational data to identify a particular user (e.g., by matching an email address or other identifier to a particular user). In at least one embodiment, expert selection model 713 can optionally identify team data 728 associated with the identified expert. For example, expert selection model 713 can access organizational data to identify a team with which expert prediction 726 is affiliated. Finally, as shown in FIG. 7B, expert selection model 713 can provide output 730. In one or more embodiments, output 730 includes expert prediction 726. In at least one embodiment, output 730 can additionally include team information associated with expert prediction 726.

Although FIG. 7B illustrates expert selection model 713 as a multi-layer perceptron, alternate architectures are possible for expert selection model 713. For example, expert selection model 713 can include one or more long short-term memory (“LSTM”) layers, feed forward layers, and/or max pooling layers. Additionally or alternatively, expert selection model 713 may be structured as a recurrent neural network, a deep convolutional network, or any other type of neural network suitable for identifying experts. Additionally or alternatively, the content management system 104 can implement the features and functionality of the expert selection model 713 across a combination of several neural networks. For example, the content management system 104 can apply a first neural network to an input to extract a key topic. The content management system 104 can then apply a second neural network to the key topic output of the first neural network. The content management system 104 can train each of the one or more neural networks separately or in combination with each other.

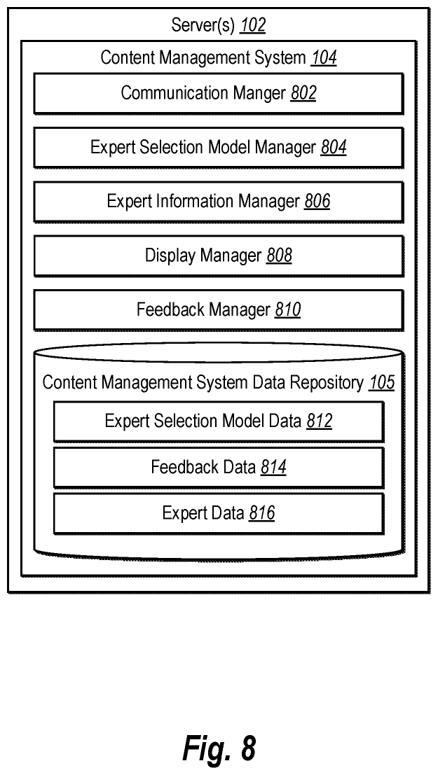

FIG. 8 illustrates a schematic diagram of content management system 104 hosted by server(s) 102. As shown, content management system 104 can include communication manager 802, expert selection model manager 804, expert information manager 806, display manager 808, and feedback manager 810. In one or more embodiments, content management system 104 can access content management system data repository 105 including expert selection model data 812, feedback data 814, and expert data 816.

Components 802-810 of content management system 104 can comprise software, hardware, or both. For example, components 802-810 can comprise one or more computer-executable instructions stored on a computer readable storage medium and executable by one or more processors of one or more computing devices. When executed by the one or more processors, the one or more computer-executable instructions of content management system 104 can cause a computing device(s) to perform the features and methods described herein. Alternatively, components 802-810 can comprise a special purpose processing device to perform a certain function or group of functions. Additionally, or alternatively, components 802-810 can comprise a combination of computer-executable instructions and hardware. Although the features and functionality of content management system 104 is described in relation to server(s) 102, part or all of the features and functionality of content management system 104 can reside on and be performed by a client computing device.

As mentioned above, and as shown in FIG. 8, content management system 104 includes communication manager 802. In one or more embodiments, communication manager 802 handles communications between content management system 104 and one or more client computing devices. For example, communication manager 802 can receive expert assistance queries from client computing devices. Furthermore, communication manager 802 can provide identified expert information from content management system 104 to one or more client computing devices.

As mentioned above, and as shown in FIG. 8, content management system 104 includes expert selection model manager 804. In one or more embodiments, expert selection model manager 804 handles activities associated with an expert selection model utilized by content management system 104. For example, expert selection model manager 804 generates training data based on data source inputs. More specifically, as discussed above with regard to FIG. 7A, expert selection model manager 804 can index and extract features from one or more data source inputs in order to generate expert selection mode training data.

Furthermore, expert selection model manager 804 can utilize the generated training data to trains an expert selection model. For example, utilizing any training technique (e.g., such as feed-forward-back-propagation training), expert selection model manager 804 can train the expert selection model until a measure of loss is minimized. Expert selection model manager 804 can also periodically retrain the expert selection model, such as after passage of a predetermined period of time, or in response to updated information (e.g., updated data source inputs) or received feedback.

As mentioned above, and as shown in FIG. 8, content management system 104 includes an expert information manager 806. In one or more embodiments, expert information manager 806 identifies and provides information associated with an expert identified by the trained expert selection model. For example, in response to the expert selection model identifying an expert relative to a particular key topic, expert information manager 806 can identify contact information associated with the identified expert. Expert information manager 806 can also identify team information for a team corresponding to the identified expert.

Additionally, expert information manager 806 can also identify one or more data source inputs that correspond with (e.g., are authored by) the identified expert, and are also responsive to the received expert assistance query. For example, in response to receiving an expert assistance query including a particular key topic and an identified expert from the expert selection model, expert information manager 806 can access an index of data source inputs (e.g., such as described above with reference to FIG. 7A) in order to identify data source inputs authored by the identified expert and associated with one or more features that correspond to the particular key topic. In one or more embodiments, expert information manager 806 can utilize a scoring approach to identify data source inputs authored by the expert that are most strongly correlated to the key topic. For example, expert information manager 806 can analyze an identified data source input to determine an age of the data source input (e.g., when the data source input was created), whether the identified expert is a sole author or a contributing author, how strongly the data source input correlates with the key topic (e.g., based on a title of the data source input, a keyword analysis of the data source input), and a file type of the data source input (e.g., a PDF white paper document may be scored higher than an email with no attachments).

Based on this analysis, expert information manager 806 can assign a score to the data source input reflecting how responsive (e.g., how “helpful”) the data source input is with regard to the key topic. Additionally, expert information manager 806 can weight certain data source inputs higher than others. For example, expert information manager 806 may weight a white paper PDF higher than an email, even when both data source inputs mention the same key topic in detail. In at least one embodiment, expert information manager 806 can rank the identified data source input based on the determined scores, and provide a threshold number of the highest ranked data source inputs.

As mentioned above, and as shown in FIG. 8, content management system 104 includes a display manager 808. In one or more embodiments, display manager 808 generates a display utilizing the results of the expert selection model and the information identified by expert information manager 806. For example, display manager 808 can generate an expanding display (e.g., such as shown in FIGS. 3B and 3C above) including selectable hyperlinked display elements that serve to identify the expert associated with the expert assistance query, provide contact information associated with the expert and/or the expert's team, and provide one or more identified data source inputs that correlated with the identified expert and are responsive to the expert assistance query.

As mentioned above, and as shown in FIG. 8, content management system 104 includes a feedback manager 810. In one or more embodiments, feedback manager 810 determines when and how to solicit feedback associated with previously provided expert information. For example, in response to content management system 104 providing one or more identified experts associated with an expert assistance query, feedback manager 810 can further detect a user interaction with any of the provided display associated with at least one of the experts. In response to the detected the user interaction, feedback manager 810 can then track a predetermined amount of time (e.g., 24 hours, 72 hours) from the detected user interaction before soliciting feedback from the querying user. Upon elapse of the predetermined amount of time, feedback manager 810 can then solicit feedback from the querying user (e.g., via content management system application 108a on client computing device 106a) seeking confirmation that the expert in association with which feedback manager 810 detected a user interaction was “helpful.” For example, feedback manager 810 can request feedback by way of freestyle text input (e.g., a text box), by way of pre-generated selections (e.g., associated with radio buttons as in FIG. 5B), by way of notifications (e.g., as in FIG. 4B), by way of audio-to-text input, or by way of any other suitable type of feedback mechanism. Feedback manager 810 can provide the received feedback information to expert selection model manager 804 for use in retraining the expert selection model.

As mentioned above, content management system 104 interacts with content management system data repository 105. As shown in FIG. 8, content management system data repository 105 includes at least one expert selection model data 812, feedback data 814, and expert data 816. In one or more embodiments, expert selection model data 812 can include expert selection model training data and at least one expert selection model (e.g., expert selection model 713), such as described herein. Additionally, feedback data 814 includes feedback information solicited in response to providing expert information and utilized to retrain an expert selection model, such as described herein. Moreover, expert data 816 includes expert information identified and provided in response to an identified expert, such as described herein.

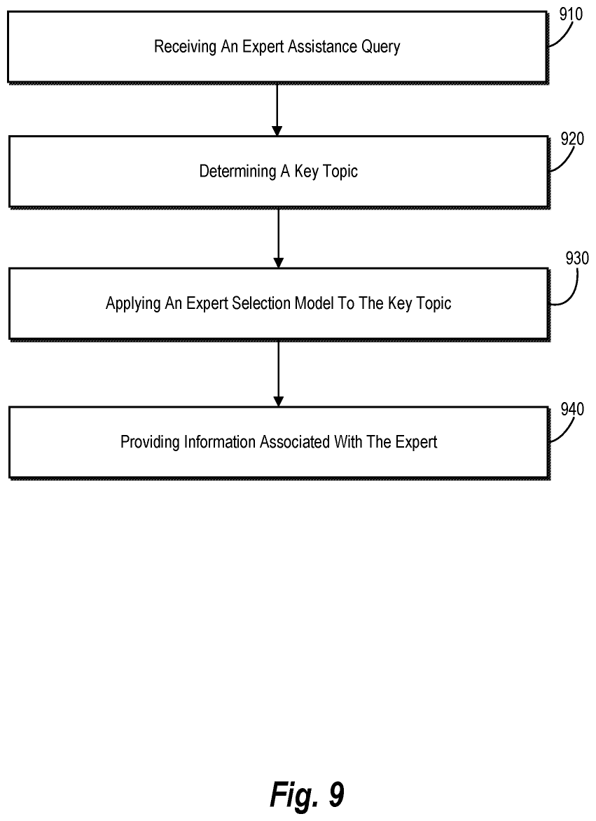

FIGS. 1-8, the corresponding text, and the examples, provide a number of different systems and devices for identifying and providing information associated with an expert relative to an expert assistance query. In addition to the foregoing, embodiments of the present disclosure can also be described in terms of flowcharts comprising acts and acts in a method for accomplishing a particular result. For example, FIG. 9 illustrates a flowchart of exemplary methods in accordance with one or more embodiments of the present disclosure. The methods described in relation to FIG. 9 may be performed with less or more acts/acts or the acts/acts may be performed in differing orders. Additionally, the acts/acts described herein may be repeated or performed in parallel with one another or in parallel with different instances of the same or similar acts/acts.

FIG. 9 illustrates a flowchart of one example method 900 of identifying and providing information associated with a key topic expert. Method 900 includes an act 910 of receiving an expert assistance query. In particular, act 910 can involve receiving, from a client computing device associated with a user, an expert assistance query.

As further shown in FIG. 9, method 900 includes an act 920 of determining a key topic. In particular, act 920 can involve determining a key topic based on the expert assistance query. For example, determining a key topic based on the expert assistance query can include utilizing keyword analysis to identify the key topic within the expert assistance query.

Additionally, method 900 includes an act 930 of applying an expert selection model to the key topic. In particular, act 930 can involve identifying an expert associated with the key topic by applying to the key topic an expert selection model trained to determine an expert user associated with a topic based on a plurality of data source inputs associated with a plurality of users. For example, method 900 can include training the expert selection model by applying the expert selection model to training data source inputs to generate predicted expert identifications; and comparing the predicted expert identifications with training users corresponding to the training data source inputs to modify parameters of the expert selection model to reduce a measure of loss. The plurality of data source inputs associated with the plurality of users comprises two or more of: emails, text messages, instant messages, computer code, digital documents, digital presentations, digital calendars, organizational data, and digital media. In one or more embodiments, the expert selection model can include a key topic extraction layer, one or more perceptron layers, and/or at least one user matching layer. In one or more embodiments, method 900 can also include identifying the expert by receiving, from the trained expert selection model, the expert associated with the key topic identified from the plurality of users.

As further shown in FIG. 9, method 900 includes an act 940 of providing information associated with the expert. In particular, act 940 can involve providing, for display on the client device, information associated with the identified expert. For example, method 900 can further include determining at least one of contact information associated with the identified expert, team information associated with the identified expert, data source inputs associated with the identified expert, or organizational information associated with the identified expert. In at least one embodiment, providing information associated with the identified expert includes providing at least one of the contact information associated with the identified expert, the team information associated with the identified expert, the data source inputs associated with the identified expert, or the organizational information associated with the identified expert.

In one or more embodiments, method 900 further includes providing, to the client device, a follow-up query based on providing the identified expert as a result to the expert assistance query; and updating the expert selection model based on the response to the follow-up query. Additionally, in one or more embodiments, method 900 can include providing a notification to a client device associated with the identified expert based on providing information associated with the identified expert in response to the expert assistance query.

In one or more embodiments, method 900 also includes receiving, from the client device associated with the identified expert, an indication of approval or an indication of disapproval that indicates whether or not the identified expert considers themselves as an expert for the key topic, and updating the expert selection model based on the indication of approval or the indication of disapproval. In at least one embodiment, method 900 includes receiving, from the client device, an indication of a selection of the information associated with the identified expert, and initiating a communication between the client device and a client device associated with the identified expert in response to the indication of the selection. Moreover, in at least one embodiment, prior to applying to the key topic the expert selection model, identifying a prior expert assistance query related to the received expert assistance query; determining a prior expert corresponding with the prior expert assistance query; and providing, for display on the client device, information associated with the prior expert along with the information associated with the identified expert.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

A processor can include any processing unit or device that processes instructions in a computing system. For example, a processor can include, but is not limited to, one or more of a central processing unit, a graphics processing unit, a field programmable gate array, an accelerated processing unit, a digital signal processor, or an integrated processor. A computing system can also include any number of processors for processing individually (e.g., by a single processor) or together (e.g., by a plurality of different processors or processor cores).

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general purpose computer to turn the general purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates a block diagram of exemplary computing device 1000 that may be configured to perform one or more of the processes described above. One will appreciate that client devices described herein and/or the content management system 104 may comprise one or more computing devices such as computing device 1000. As shown by FIG. 10, computing device 1000 can comprise processor 1002, memory 1004, storage device 1006, I/O interface 1008, and communication interface 1010, which may be communicatively coupled by way of communication infrastructure 1012. While an exemplary computing device 1000 is shown in FIG. 10, the components illustrated in FIG. 10 are not intended to be limiting. Additional or alternative components may be used in other embodiments. Furthermore, in certain embodiments, computing device 1000 can include fewer components than those shown in FIG. 10. Components of computing device 1000 shown in FIG. 10 will now be described in additional detail.

In particular embodiments, processor 1002 includes hardware for executing instructions, such as those making up a computer program. As an example, and not by way of limitation, to execute instructions, processor 1002 may retrieve (or fetch) the instructions from an internal register, an internal cache, memory 1004, or storage device 1006 and decode and execute them. In particular embodiments, processor 1002 may include one or more internal caches for data, instructions, or addresses. As an example and not by way of limitation, processor 1002 may include one or more instruction caches, one or more data caches, and one or more translation lookaside buffers (TLBs). Instructions in the instruction caches may be copies of instructions in memory 1004 or storage 1006. Additionally, processor 1002 can include or represent one or more processors or processor cores.

Memory 1004 may be used for storing data, metadata, and programs for execution by the processor(s). Memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1004 may be internal or distributed memory.

Storage device 1006 includes storage for storing data or instructions. As an example and not by way of limitation, storage device 1006 can comprise a non-transitory storage medium described above. Storage device 1006 may include a hard disk drive (HDD), a floppy disk drive, flash memory, an optical disc, a magneto-optical disc, magnetic tape, or a Universal Serial Bus (USB) drive or a combination of two or more of these. Storage device 1006 may include removable or non-removable (or fixed) media, where appropriate. Storage device 1006 may be internal or external to computing device 1000. In particular embodiments, storage device 1006 is non-volatile, solid-state memory. In other embodiments, Storage device 1006 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1008 allows a user to provide input to, receive output from, and otherwise transfer data to and receive data from computing device 1000. I/O interface 1008 may include a mouse, a keypad or a keyboard, a touch screen, a camera, an optical scanner, network interface, modem, other known I/O devices or a combination of such I/O interfaces. I/O interface 1008 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1008 is configured to provide graphical data to a display for presentation to a user. The graphical data may be representative of one or more graphical user interfaces and/or any other graphical content as may serve a particular implementation.

Communication interface 1010 can include hardware, software, or both. In any event, communication interface 1010 can provide one or more interfaces for communication (such as, for example, packet-based communication) between computing device 1000 and one or more other computing devices or networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1010 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1010 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, communication interface 1010 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

Communication infrastructure 1012 may include hardware, software, or both that couples components of computing device 1000 to each other. As an example and not by way of limitation, communication infrastructure 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

FIG. 11 is a schematic diagram illustrating an environment 1100 within which one or more embodiments of content management system 104 can be implemented. For example, as shown in FIG. 11, content management system 1102 (e.g., content management system 104) may generate, store, manage, receive, and send digital content (such as digital videos). For example, content management system 1102 may send and receive digital content to and from client devices 1106 by way of network 1104. In particular, content management system 1102 can store and manage a collection of digital content. Content management system 1102 can manage the sharing of digital content between computing devices associated with a plurality of users. For instance, content management system 1102 can facilitate a user sharing a digital content with another user of content management system 1102.

In particular, content management system 1102 can manage synchronizing digital content across multiple client devices 1106 associated with one or more users. For example, a user may edit digital content using client device 1106. The content management system 1102 can cause client device 1106 to send the edited digital content to content management system 1102. Content management system 1102 then synchronizes the edited digital content on one or more additional computing devices.

In addition to synchronizing digital content across multiple devices, one or more embodiments of content management system 1102 can provide an efficient storage option for users that have large collections of digital content. For example, content management system 1102 can store a collection of digital content on content management system 1102, while the client device 1106 only stores reduced-sized versions of the digital content. A user can navigate and browse the reduced-sized versions (e.g., a thumbnail of a digital image) of the digital content on client device 1106. In particular, one way in which a user can experience digital content is to browse the reduced-sized versions of the digital content on client device 1106.

Another way in which a user can experience digital content is to select a reduced-size version of digital content to request the full- or high-resolution version of digital content from content management system 1102. In particular, upon a user selecting a reduced-sized version of digital content, client device 1106 sends a request to content management system 1102 requesting the digital content associated with the reduced-sized version of the digital content. Content management system 1102 can respond to the request by sending the digital content to client device 1106. Client device 1106, upon receiving the digital content, can then present the digital content to the user. In this way, a user can have access to large collections of digital content while minimizing the amount of resources used on client device 1106.

Client device 1106 may be a desktop computer, a laptop computer, a tablet computer, a personal digital assistant (PDA), an in- or out-of-car navigation system, a smart TV, a virtual reality (VR) or augmented reality (AR) device, a handheld device, a wearable device, a smartphone or other cellular or mobile phone, or a mobile gaming device, other mobile device, or other suitable computing devices. Client device 1106 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 1104.

Network 1104 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1106 may access content management system 1102.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A method comprising:
receiving, from a client device associated with a user, an expert assistance query;
determining a key topic based on the expert assistance query;
identifying an expert associated with the key topic by applying to the key topic an expert selection model trained to determine an expert user associated with a topic based on a plurality of data source inputs associated with a plurality of users; and
providing, for display on the client device, information associated with the identified expert.

2. The method as recited in claim 1, further comprising:
determining at least one of contact information associated with the identified expert, team information associated with the identified expert, data source inputs associated with the identified expert, or organizational information associated with the identified expert; and
wherein providing information associated with the identified expert comprises providing at least one of the contact information associated with the identified expert, the team information associated with the identified expert, the data source inputs associated with the identified expert, or the organizational information associated with the identified expert.

3. The method as recited in claim 1, wherein the plurality of data source inputs associated with the plurality of users comprises two or more of: emails, text messages, instant messages, computer code, digital documents, digital presentations, digital calendars, organizational data, and digital media.

4. The method as recited in claim 1, further comprising:
providing, to the client device, a follow-up query based on providing the identified expert as a result to the expert assistance query; and
updating the expert selection model based on the response to the follow-up query.

5. The method as recited in claim 1, further comprising providing a notification to a client device associated with the identified expert based on providing information associated with the identified expert in response to the expert assistance query.

6. The method as recited in claim 5, further comprising:
receiving, from the client device associated with the identified expert, an indication of approval or an indication of disapproval that indicates whether or not the identified expert considers themselves as an expert for the key topic; and
updating the expert selection model based on the indication of approval or the indication of disapproval.

7. The method as recited in claim 1, further comprising:
receiving, from the client device, an indication of a selection of the information associated with the identified expert; and
initiating a communication between the client device and a client device associated with the identified expert in response to the indication of the selection.

8. The method as recited in claim 1, wherein identifying the expert associated with the key topic further comprises:
prior to applying to the key topic the expert selection model, identifying a prior expert assistance query related to the received expert assistance query;
determining a prior expert corresponding with the prior expert assistance query; and
providing, for display on the client device, information associated with the prior expert along with the information associated with the identified expert.

9. The method as recited in claim 1, further comprising training the expert selection model by:
applying the expert selection model to training data source inputs to generate predicted expert identifications; and
comparing the predicted expert identifications with training users corresponding to the training data source inputs to modify parameters of the expert selection model to reduce a measure of loss.

10. The method as recited in claim 1, wherein the expert selection model comprises: a key topic extraction layer, one or more perceptron layers, and at least one user matching layer.

11. A system comprising:
at least one processor; and
at least one non-transitory computer-readable storage medium storing instructions that, when executed by the at least one processor, cause the system to:
receive, from a client device associated with a user, an expert assistance query;
determine a key topic based on the expert assistance query;
identify an expert associated with the key topic by applying to the key topic an expert selection model trained to determine an expert user associated with a topic based on a plurality of data source inputs associated with a plurality of users; and
provide, for display on the client device, information associated with the identified expert.

12. The system as recited in claim 11, further storing instructions that, when executed by the at least one processor, cause the system to:
determine at least one of contact information associated with the identified expert, team information associated with the identified expert, data source inputs associated with the identified expert, or organizational information associated with the identified expert; and
provide information associated with the identified expert by providing at least one of the contact information associated with the identified expert, the team information associated with the identified expert, the data source inputs associated with the identified expert, or the organizational information associated with the identified expert.

13. The system as recited in claim 11, wherein the plurality of data source inputs associated with the plurality of users comprises two or more of: emails, text messages, instant messages, computer code, digital documents, digital presentations, digital calendars, organizational data, and digital media.

14. The system as recited in claim 11, further storing instruction that, when executed by the at least one processor, cause the system to:
provide, to the client device, a follow-up query based on providing the identified expert as a result to the expert assistance query; and
update the expert selection model based on the response to the follow-up query.

15. The system as recited in claim 11, further storing instructions that, when executed by the at least one processor, cause the system to, provide a notification to a client device associated with the identified expert based on providing information associated with the identified expert in response to the expert assistance query.

16. The system as recited in claim 11, further storing instructions that, when executed by the at least one processor, cause the system to:
receive, from the client device associated with the identified expert, an indication of approval or an indication of disapproval that indicates whether or not the identified expert considers themselves as an expert for the key topic; and
update the expert selection model based on the indication of approval or the indication of disapproval.

17. A non-transitory computer-readable medium storing instructions that, when executed by at least one processor, cause at least one computing device to:
receive, from a client device associated with a user, an expert assistance query;
determine a key topic based on the expert assistance query;
identify an expert associated with the key topic by applying to the key topic an expert selection model trained to determine an expert user associated with a topic based on a plurality of data source inputs associated with a plurality of user; and
provide, for display on the client device, information associated with the identified expert.

18. The non-transitory computer-readable medium as recited in claim 17, further storing instructions that, when executed by the at least one processor, cause the at least one computing device to:
receive, from the client device, an indication of a selection of the information associated with the identified expert; and
initiate a communication between the client device and a client device associated with the identified expert in response to the indication selection.

19. The non-transitory computer-readable medium as recited in claim 17, further storing instructions that, when executed by the at least one processor, cause the at least one computing device to further identify the expert associated with the key topic by:
prior to applying to the key topic the expert selection model, identifying a prior expert assistance query corresponding to the received expert assistance query;
determining a prior expert corresponding with the prior expert assistance query; and
providing, for display on the client device, information associated with the prior expert along with the information associated with the identified expert.

20. The non-transitory computer-readable medium as recited in claim 17, further storing instructions that, when executed by the at least one processor, cause the at least one computing device to train the expert selection model by:
applying the expert selection model to training data source inputs to generate predicted expert identifications; and
comparing the predicted expert identifications with training users corresponding to the training data source inputs to modify parameters of the expert selection model to reduce a measure of loss.
